(19) United States
(12) Patent Application Publication
(10) Pub. No.: US 2006/0170895 A1
(43) Pub. Date: Aug. 3, 2006

(54) Projection exposure apparatus

(75) Inventor: Damian Fiolka, Oberkochen (DE)

Correspondence Address: DARBY & DARBY P.C., P. O. BOX 5257, NEW YORK, NY, 10150-5257, US

(73) Assignee: Carl Zeiss SMT AG, Oberkochen (DE)

(21) Appl. No.: 11/313,253

(22) Filed: Dec. 19, 2005

Related U.S. Application Data
(60) Provisional application No. 60/638,046, filed on Dec. 20, 2004.

(51) Int. Cl. G03B 27/54

(52) U.S. Cl. 355/67; 355/53

(57) ABSTRACT

The invention relates to a projection exposure apparatus, in particular for the field of microlithography. The projection exposure apparatus includes at least one treatment device for treating at least one blank for an optical element. The treatment device serves to alter at least one optical property of the blank.

### CROSS-REFERENCE TO RELATED APPLICATION

This application claims the benefit under 35 U.S.C. 119(e) (1) of U.S. Provisional Application No. 60/638,046 filed on Dec. 20, 2004.

### TECHNICAL FIELD

The invention relates to a projection exposure apparatus, in particular for applications in the field of microlithography. The invention further relates to a system with a projection exposure apparatus as well as to a method of operating a projection exposure apparatus and a method of producing a micro-structured component.

### BACKGROUND OF THE INVENTION

With the help of a projection exposure apparatus, the structures of a mask can be transferred precisely onto a wafer or another substrate, which for this purpose has been provided with a light-sensitive coating. In order to allow a precise transfer, in particular also for fine structures, very demanding requirements are imposed on the light polarization and on the light distribution in the pupil plane and in the field plane, more specifically in the object plane in which the mask is arranged. Failure to meet the respective specifications can lead to exposure-dosage errors in the light sensitive coating on the wafer and can consequently have a negative influence on the image quality.

Up to a certain degree, the specifications can be met by using optical elements made of an optical material of excellent quality and by using elaborate technical measures for mounting the elements. However, this involves very high production efforts and very high costs. Furthermore, the properties of the optical elements can change with increasing exposure to radiation.

However, it is also possible to tolerate minor inadequacies of the optical system and to correct their effects, for example by means of filter devices. In this way, the requirements on the illumination quality can be met at a reasonable cost.

Filter devices for projection exposure apparatus are known in a multitude of different designs. The known state of the art includes in particular concepts for adjustable filter devices. For example, EP 1 020 769 A2 discloses among other things, a device for use in photolithography for adjusting an illumination field. To perform the adjustment, platelets that are arranged adjacent to each other are selectively moved into or out of the illumination field.

For example, a projection exposure apparatus with a filter, which is arranged in a pupil plane and has a filter element that is rotatable about the optical axis of the optical projection system, is disclosed in DE 100 43 315 C1. Over the filter surface, the degree of transmissivity of the filter element is not rotationally symmetric relative to the optical axis.

The patent application publication US 2003/0067591 A1 discloses in particular an optical illumination system in which at least two filters are arranged one after the other in the light ray path. The transmissivity distribution of the filters in the direction transverse to the ray path conforms to a third-order function. At least one of the filters is movable in a direction transverse to the ray path.

### SUMMARY OF THE INVENTION

One object of the invention is to achieve a high-quality illumination that is maintained with the highest possible durability in a projection exposure apparatus.

A solution meeting this objective is accomplished through at least one treatment device for treating at least one blank for an optical element, wherein at least one optical property of the blank can be permanently altered by means of said treatment device.

The microlithography projection apparatus is intended, in particular, for the field of microlithography and includes at least one treatment device for treating at least one blank for an optical element, wherein the treatment serves to permanently alter at least one optical property of the blank.

A projection exposure apparatus according to this concept has in itself the capability to produce an optical element with the desired optical properties. Thus, deficiencies of the optical system of the projection exposure apparatus can be compensated up to a certain degree, so that the requirements on the optical system overall can be lowered. Furthermore, undesirable changes in the properties of the optical system can be countered in a close time frame and without a major effort.

The treatment device is, in particular, of the type which allows the transmissivity of the blank to be influenced. In the interest of influencing the properties of the optical system in the best way possible, it is of advantage if the treatment device allows any desired transmissivity distribution to be produced in the blank. As an example, this objective is attained without problems in a preferred embodiment of the projection exposure apparatus in which the treatment device is designed to apply an additive material to the blank, in particular, through a printing technique. The additive material has an absorbent effect, so that the transmissivity can be influenced by way of the coating thickness that is being deposited. Without involving a major operation and expense, this concept allows the additive material to be applied to the blank in any desired lateral distribution, and thus the production of a desired distribution function for the transmissivity.

The scope of the invention includes in particular a projection exposure apparatus for use in microlithography applications, wherein the apparatus is equipped with at least one printing device to print on at least one blank for an optical element. The printing device in this context can be any type of printer, such as for example a laser printer, ink jet printer, etc., and also devices other than printers that can produce a structure on the surface of or inside the blank. This includes, for example, techniques for removing or transforming material locally, such as a laser-writing technique and others.

In order to match the treatment of the blank as precisely as possible to the actually existing conditions, at least one measuring device can be provided for measuring a quantity on which the treatment of the blank is based.

Furthermore, the projection exposure apparatus can be equipped with at least one transport device for transporting the optical element from the location of treatment to its operating location in the ray path. Treating the blank at its location in the ray path is not possible as a rule, because of space considerations alone, so that the transport device is needed in order to achieve a high degree of automation.

The blank can be configured as a flat piece, with two design versions being used with preference. In the first design version, the blank is configured as a plate, in particular as a glass plate. It is in this case advantageous if a storage device is provided for keeping a supply of blanks. This serves to ensure that a sufficient number of blanks are available in the projection exposure apparatus in a space-saving and easily accessible arrangement. In the second design version, the blank is made of a flexible material. For convenience in handling, it is advantageous here if the blank is configured as a ribbon, in particular as a foil ribbon. A blank of this kind can be stored in a space-saving manner on a roll, so that it can be transported to the location of treatment and from there into the ray path by unwinding the material from the roll.

The optical element produced from the blank is preferably a filter or another corrective element, in particular for correcting the light distribution. The corrective effect or filter effect can be matched to the actual conditions prevailing at the time the optical element is produced. As the conditions change, a new optical element can be made. The optical element is preferably arranged in a pupil plane or an object plane of the projection exposure apparatus.

The invention further relates to a system including a projection exposure apparatus and a treatment device for treating a blank for an optical element of the projection exposure apparatus, wherein the treatment device serves to permanently alter at least one optical property of the blank. As a distinguishing feature of the system, a data connection is provided between the projection exposure apparatus and the treatment device. The data connection allows the treatment of the blank to be influenced by the projection exposure apparatus and to be matched to the conditions prevailing in the projection exposure apparatus. Thus, the treatment of the blank can be performed automatically also in a case where the treatment device is configured as a separate entity from the projection exposure apparatus. If in addition a transport device is provided for transporting the optical blank from the treatment device into the ray path of the projection exposure apparatus, the positioning of the optical element can likewise be performed automatically. In order to realize the latter possibility, it is advantageous if the projection exposure apparatus and the treatment device are arranged in the same production facility.

In the inventive method for operating a projection exposure apparatus, in particular for microlithography applications, an optical element is produced by at least one treatment device that is integrated in the projection exposure apparatus or communicates through a data connection with the projection exposure apparatus, and following this step the optical element is positioned in the ray path of the projection exposure apparatus. This process can be performed by the projection exposure apparatus in a fully automatic way.

The invention further relates to a method for producing a micro-structured component. In the latter method, an image of a structure formed on a mask is projected onto a light-sensitive coating of a component by means of a projection exposure apparatus designed according to the foregoing description. The further processing of the component is then carried out on the basis of the image of the structure.

### BRIEF DESCRIPTION OF THE DRAWING FIGURES

The invention will hereinafter be explained in more detail through the examples of embodiments represented in the drawing, wherein:

FIG. 1 shows a schematic representation of an example of an embodiment of a projection exposure apparatus 1 for microlithography applications, which is configured in accordance with the invention;

FIG. 2 represents a detail view of a section of the first foil; and

FIG. 3 shows an example of a second embodiment of the projection exposure apparatus in a form of representation that is analogous to FIG. 1.

### DETAILED DESCRIPTION OF PREFERRED EMBODIMENTS

FIG. 1 shows a schematic representation of an example of an embodiment of a projection exposure apparatus 1 designed for microlithography applications and configured in accordance with the invention. The projection exposure apparatus 1 includes a light source 2 which could also be arranged with a spatial separation from the other components of the projection exposure apparatus 1. The type of light source 2 depends in particular on the wavelength at which the projection exposure apparatus 1 is to be operated. For example to obtain a wavelength of 193 nm, one can use an ArF excimer laser for the light source 2.

Following the light source 2 in the ray path are a first optical module 3, a second optical module 4 and a third optical module 5, each of which contains a series of optical subassemblies. A first filter 7 is arranged in a pupil plane 6 between the first optical module 3 and the second optical module 4. Arranged in an object plane 8 between the second optical module 4 and the third module 5 are a second filter 9 and a mask 10. A wafer 12 is arranged in an image plane 11 which is located in the ray path after the third optical module 5. Further arranged in the area of the image plane 11 are a first intensity sensor 13 and a second intensity sensor 14 which can be moved parallel to the image plane 11. The second intensity sensor 14 is preceded in the light path by a rotating polarization beam splitter 15.

The two intensity sensors 13 and 14 are connected to a processor 16 which controls a first printer 17 and a second printer 18. The first printer 17 prints on a first foil 19 which is unwound from a first supply roll 20 and wound onto a first take-up roll 21. The first supply roll 20 and the first take-up roll 21 are arranged laterally of the ray path in such a way that the imprint produced by the first printer 17 on the first foil 19 can be positioned in the pupil plane 6 in the ray path as the first filter 7. In analogous manner, the second printer 18 prints on a second foil 22 which is unwound from a second supply roll 23 and wound onto a second take-up roll 24. The imprint produced by the second printer 18 on the second foil 22 can be positioned in the object plane 8 in the ray path as the second filter 9. Each of the foils 19 and 22 is made of a material that is sufficiently transparent at the wavelength being used for operating the projection exposure apparatus 1. At a wavelength of 193 nm, one could use as a foil material, e.g., a Teflon material (Teflon AF) that is transparent at this wavelength, or a fluoropolymer which is available, e.g., under the trade name Cytop and which also serves as pellicle material.

With the projection exposure apparatus 1, the structures on the mask 10 are projected onto the surface of the wafer 12 which has a light-sensitive coating. In this process, the mask 10 is illuminated by means of the light source 2, the first optical module 3 and the second optical module 4, and an image of the mask 10 is projected onto the wafer 12 by means of the third optical module 5. In order to meet the specifications for the illumination quality required in the light distribution on the mask 10 within reasonable limits of cost and effort spent on the optical modules 3 and 4, the filters 7 and 9 are provided as corrective elements. The specifications relate, for example, to the light distribution in the pupil plane 6 and in the object plane 8 and to the polarization. The light distribution and polarization distribution in the pupil plane 6 and in the object plane 8 are, however, not of a static nature but are subject to change in the course of time. This is a consequence, e.g., of the changes in the properties of the optical subassemblies used in the optical modules 3 and 4 which occur with increasing radiation exposure of these subassemblies.

In order to achieve a durable conformance to the requirements imposed on the illumination of the mask 10, the projection exposure apparatus is not merely fitted at one time with appropriately designed filters 7 and 9. Rather, new filters 7 and 9 are made again and again and are placed in the ray path. It can be envisaged, for example, that new filters 7 and 9 are produced when there is a change in the illumination mode, when a need for correction has been detected, or after predetermined operating periods have elapsed. To make new filters, the mask 10 and the wafer 12 are removed from the ray path. A predetermined area of the image plane 11 is scanned with the first intensity sensor 13 to determine the intensity distribution of the light. Based on this information, data about the uniformity can be derived. By means of the polarization beam splitter 15 and the second intensity sensor 14, the polarized shares of the light are determined relative to two mutually orthogonal directions in the image plane 11. If the properties of the third optical module 5 do not need to be considered, the last-mentioned measurements can be performed in the object plane 8 instead of in the image plane 11.

The respective positions of the intensity sensors 13 and 14 and the rotation of the polarization beam splitter 15 are controlled by the processor 16. Furthermore, the data determined by the intensity sensors 13 and 14 are fed into the processor 16. In addition, the light distribution and the polarization in the pupil plane 6 are determined by using appropriate measurement techniques which are known per se and will therefore not be explained in detail. In this case, too, the control is performed by means of the processor 16, and the data are again fed into the processor 16. Based on the data obtained in this way, the processor 16 calculates respective distributions of gray tones for the first filter 7 in the pupil plane 6 and the second filter 9 in the pupil plane 8, so that the given specifications are met for the illumination characteristics of uniformity, telecentricity, ellipticity, and pole balance. The gray tone distributions calculated in this manner can be configured in any way desired and are, for example, not limited to black and white surface areas with a simple geometry.

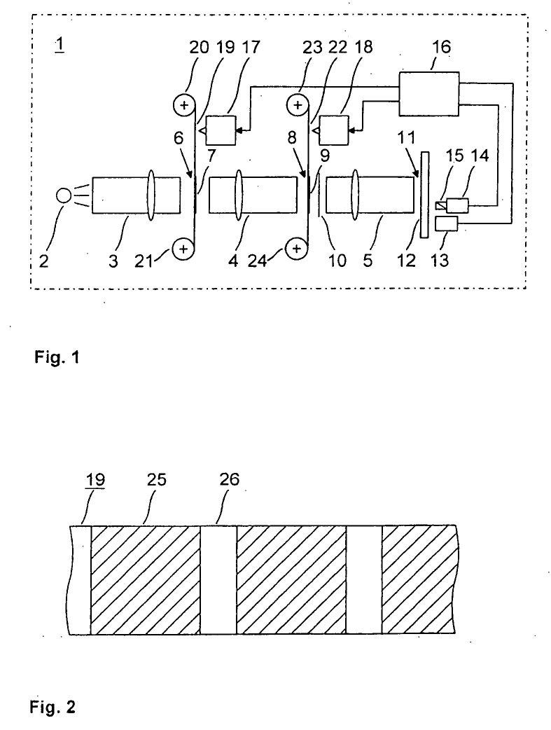

Next, after the gray tone distributions have been determined, they are printed by the first printer 17 onto the first foil 19 and, if applicable, by the second printer 18 onto the second foil 22. A first foil 19 that has been imprinted in this manner is shown in FIG. 2. The printers 17 and 18 can be, for example, laser printers, ink jet printers, etc. It is only important that the printers 17 and 18 be suitable for printing on the foils 19 and 22. By advancing respective sections of the foils 19 and 22 from the supply rolls 20 and 23 to the take-up rolls 21 and 24, the newly printed sections of the foils 19 and 22 are transported into the ray path. In the manner of the foregoing description, filters 7 and 9 which are matched to the currently prevailing illumination conditions are produced and placed in the ray path.

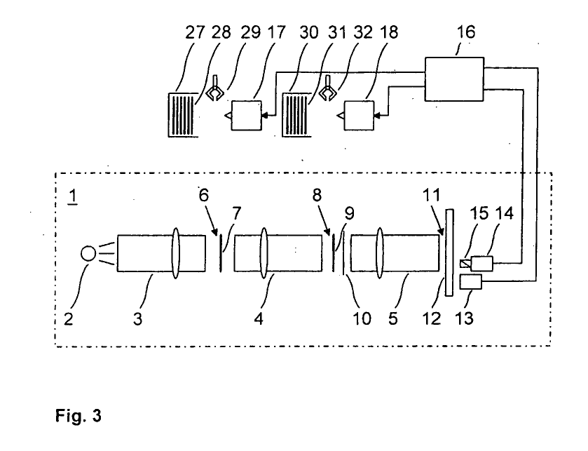

In the example of the projection exposure apparatus 1 that is shown in FIG. 1, all of the components needed for the making of the filters 7 and 9 are integrated into the projection exposure apparatus 1, so that for a filter change, no intervention from the outside occurs in the projection exposure apparatus 1. As an alternative possibility, at least some of the last-mentioned components can also be arranged outside of the projection exposure apparatus 1. This is illustrated in FIG. 3.

FIG. 2 represents a detail view of a section of the first foil 19. In the section shown in the drawing, the first foil 19 has several imprinted areas 25 that are separated from each other by non-imprinted areas 26. In principle, the non-imprinted areas 26 can be omitted, so that the imprinted areas 25 are directly bordering on each other. Each imprinted area 25 is configured as a gray tone distribution and represents a filter 7 which can be brought into the ray path by a transport movement of the first foil 19. The second foil 22 is imprinted in the same manner, but as a rule the two foils differ from each other in their gray tone distributions.

FIG. 3 shows an example of a second embodiment of the projection exposure apparatus 1 in a form of representation that is analogous to FIG. 1. The second embodiment differs from the first embodiment shown in FIG. 1 in regard to the arrangement and in part also in regard to the physical shape of the components used for making the filters 7 and 9. The printers 17 and 18 in the second embodiment are arranged outside of the spatial confines of the projection exposure apparatus 1. In particular, the printers 17 and 18 are arranged outside of a housing that encloses the projection exposure apparatus 1. The light source 2 can be arranged inside or outside of the housing, depending on the configuration of the light source 2.

Arranged near the first printer 17 is a first storage device 27 in which a stack of first plates 28 are stored. The first plates 28 serve as blanks for making the first filters 7 which, by means of a symbolically indicated first handling device 29, are transported to the first printer 17 and subsequently positioned in the ray path of the projection exposure apparatus 1. Analogously, a second storage device 30 holding a stack of second plates 31 is provided in proximity to the second printer 18. There is likewise a second handling device 32 for the second plates 31.

Not only the printers 17 and 18, but also the processor 16, the storage devices 27 and 30 with the plates 28 and 31, and the handling devices 29 and 32 are likewise arranged at least in part outside of the space filled by the projection exposure apparatus. Otherwise, the layout of the projection exposure apparatus 1 is analogous to the first embodiment, albeit without the foils 19 and 22, the supply rolls 20 and 23 as well as the take-up rolls 21 and 24.

To produce the filters 7 and 9, measurement values are determined and fed into the processor 16 in an analogous manner as has been described for the first embodiment. Based on the measurement values, the processor 16 calculates gray tone distributions and sends corresponding command signals to the printers 17 and 18. The gray tone distributions are printed by the printers 17 and 18 onto the plates 28 and 32 which for this purpose are taken out of the storage devices 27 and 30 by the handling devices 29 and 32 and delivered to the printers 17 and 18. The plates 28 and 31 are made of a material that is transparent at the wavelength of the light provided for the lithography process. With a wavelength of 193 nm, the plates 28 and 31 can be made of glass, carrying an anti-reflex coating. The printers 17 and 18 have to be appropriately designed in this case, so that they can print on glass. After the printing of the gray tone distributions on the plates 28 and 31 has been completed, the plates are positioned in the ray path of the projection exposure apparatus 1 by means of the handling devices 29 and 32. If the previously used filters 7 and 9 are still in place, they are removed first from the ray path. The storage devices 27 and 30 can be configured in such a way that they can receive the removed filters 7 and 9.

In a variant version of the second embodiment, the first filter 7 as well as the second filter 9 are produced and positioned in the ray path with the first printer 17, the first storage device 27, the first plates 28 and the first handling device 29. The second printer 18, the second storage device 30, the second plates 31 and the second handling device 32 are absent from this variant version.

As an alternative to the storage devices 27 and 30 with the plates 28 and 31, as well as the associated handling devices 29 and 32, it is possible in the second embodiment as well to use the foils 19 and 22, supply rolls 20 and 23 as well as the take-up rolls 21 and 24. The supply rolls 20, 23 and the take-up rolls 21, 24 are in this case arranged so that after the printing has taken place outside of the projection exposure apparatus, the rolls transport the foils 19, 22 into the light path. Conversely, the first embodiment which is shown in FIG. 1 could also be equipped with storage devices 27 and 30, plates 28 and 31 as well as handling devices 29 and 32. The foils 19 and 22, supply rolls 20 and 23 as well as take-up rolls 21 and 24 are left out in this case.

In the embodiment shown in FIG. 3, the components for making the filters 7 and 9 are arranged in immediate proximity to the projection exposure apparatus 1, so that the filters 7, 9 with the handling devices 29, 32 can be positioned in the ray path without problems. As a possible alternative, these components could also be arranged at a larger distance from the projection exposure apparatus 1. Nevertheless, in order to achieve the greatest efficiency possible in the producing and installing of the filters 7, 9, the components in this case, too, are arranged in the same production facility as the projection exposure apparatus. The transporting of the filters 7, 9 under this alternative possibility is performed by means of a modified handling device 29, 32, or manually. The processor 16 in this alternative version, too, is in data communication with the intensity sensors 13, 14 and with the polarization beam splitter 15.

As an alternative to producing the filters 7, 9 with a printing technique, one could also in all of the embodiments use other deposition methods or other techniques for locally influencing the transmissivity, as long as such alternative methods lend themselves to a sufficient level of automation. In particular, it is also possible to produce the filters 7, 9 through a writing process by means of a laser beam. Instead of reducing the transmissivity of a transparent material, the filters 7, 9 can also be produced by partially removing or modifying an opaque layer.

The invention can be used in purely refractive projection exposure apparatus 1 as well as in catadioptric projection exposure apparatus 1.

1. Projection exposure apparatus, in particular for the field of microlithography, characterized in that the apparatus comprises at least one treatment device for treating at least one blank for an optical element, wherein at least one optical property of the blank can be altered by means of said treatment device.

2. Projection exposure apparatus according to claim 1, characterized in that the treatment device is adapted to apply an additive material to the blank in particular through a printing technique.

3. Projection exposure apparatus according to one of the preceding claims, characterized in that the treatment device is adapted to permanently influence the transmissivity of the blank.

4. Projection exposure apparatus according to claims 1 or 2, characterized in that the treatment device is adapted to produce any desired distribution of the transmissivity of the blank.

5. Projection exposure apparatus for applications in microlithography, characterized in that the apparatus comprises at least one printing device for printing on at least one blank for an optical element.

6. Projection exposure apparatus according to any one of claims 1, 2 or 5, characterized in that at least one measuring device is provided for determining a measurement quantity based on which the treatment of the blank is carried out.

7. Projection exposure apparatus according to any one of claims 1, 2 or 5, characterized in that at least one transport device is provided for transporting the optical element from the location of treatment into the ray path.

8. Projection exposure apparatus according to any one of claims 1, 2 or 5, characterized in that the blank is configured as a flat piece.

9. Projection exposure apparatus according to any one of claims 1, 2 or 5, characterized in that the blank is configured as a plate, in particular as a glass plate.

10. Projection exposure apparatus according to any one of claims 1, 2 or 5, characterized in that a storage device is provided for the storing of blanks.

11. Projection exposure apparatus according to any one of claims 1, 2 or 5, characterized in that the blank is made of a flexible material.

12. Projection exposure apparatus according to claim 11, characterized in that the blank is configured as a ribbon, in particular as a foil ribbon.

13. Projection exposure apparatus according to claim 12, characterized in that a roll is provided from which the blank is unwound.

14. Projection exposure apparatus according to any one of claims 1, 2 or 5, characterized in that the optical element is configured as a corrective element for correcting in particular the light distribution.

15. Projection exposure apparatus according to any one of claims 1, 2 or 5, characterized in that the optical element is configured as a filter.

16. Projection exposure apparatus according to any one of claims 1, 2 or 5, characterized in that the optical element is arranged in at least one of a pupil plane and an object plane.

17. System comprised of a projection exposure apparatus and a treatment device for treating a blank for an optical element of the projection exposure apparatus, wherein at least one optical property of the blank can be altered by means of the treatment device, characterized in that a data connection is provided between the projection exposure apparatus and the treatment device.

18. System according to claim 17, characterized in that at least one transport device is provided for transporting the optical element from the treatment device into the ray path of the projection exposure apparatus.

19. System according to one of the claims 17 or 18, characterized in that the projection exposure apparatus and the treatment device are arranged in the same production facility.

20. Method of operating a projection exposure apparatus, in particular for applications in microlithography, comprising the steps of:
producing an optical element by at least one treatment device which is one of integrated in the projection exposure apparatus and in data communication with the projection exposure apparatus, and subsequently positioning the optical element in the ray path of the projection exposure apparatus.

21. Method of producing a micro-structured component, by means of a projection exposure apparatus according to one of the claims 1, 2, or 5 comprising the steps of:
forming an image of a structure on a mask;
projecting the image onto a light-sensitive coating of the component, and
further processing of the component on the basis of the image of the structure.
